(19) United States
(12) Patent Application Publication
(10) Pub. No.: US 2010/0005698 A1
(43) Pub. Date: Jan. 14, 2010

(54) Device for Releasing Gas Trapped in Fish

(76) Inventor: Scott D. Raus, Conroe, TX (US)

Correspondence Address: BURLESON COOKE L.L.P., 2040 NORTH LOOP 336 WEST, SUITE 123, CONROE, TX, 77304, US

(21) Appl. No.: 12/168,997

(22) Filed: Jul. 8, 2008

(51) Int. Cl. A01K 97/00

(52) U.S. Cl. 43/4; 43/1

(57) ABSTRACT

A device for venting gases from the swim bladder of fish is provided. The device includes a puncturing member that can be extended, locked in the extended position and retracted into a case. Gases are vented from the case through the puncturing member.

### BACKGROUND OF INVENTION

1. Field of Invention

The present invention generally relates to fishing and specifically to tools for releasing gases trapped in fish caught at depth.

2. Description of Related Art

Fishermen are encouraged to release the gases out of the expanded swim bladder of fish caught at depth before they are released. Failure to ventilate the swim bladder prevents the fish from diving, usually resulting in the fish's death. As of Jun. 1, 2008, Federal regulations require the use of venting tools on certain sport fish before release. See, 50 CFR 622.

The fish that have a swim bladder have a mechanism that allows them to regulate the amount of gas in their bodies, and by extension, their buoyancy. Some fish possess a pneumatic duct that connects the swim bladder to the alimentary tract, allowing quick expulsion of gas. Other fish have a “closed” swim bladder, and rely on a network of capillaries to diffuse gas out of the swim bladder. When a fish is caught at depth, and quickly brought to the surface, rapid depressurization occurs. Boyle's law describes the volume (V) change associated with this pressure (P) change. Volume (V) increases inversely proportional to pressure (P) decrease in a closed system, or P1V1=P2V2. The swim bladder of a fish caught at a depth of 33 feet and brought to the surface will double in size. If the gas is not released, allowing the swim bladder to return to near its normal size, after the fish is released it will not be able to return quickly to depth and may die as a result.

The technique of inserting a hypodermic needle into the bladder of a fish is well known, and is sometimes referred to as “fizzing.” See, e.g., A Review of “Fizzing”—A Technique for Swim Bladder Deflation, S. J. Kerr (Fisheries Section, Fish and Wildlife Branch, Ontario Ministry of Natural Resources November 2001).

The FL Sea Grant/Novak Venting Tool Kit discloses a fish venting tool kit comprising five 3 cm. plastic syringes with plungers removed, twenty-five 16 gauge needles, and a bio-hazard sharps container.

www.ventafish.com discloses a fish venting tool that operates by pushing a plunger that forces a needle into a fish's swim bladder, but does not lock in place.

www.teammarineusa.us discloses a retractable fish venting tool that operates by forcing a needle into a fish's swim bladder by sliding the needle out of a handle by utilizing a knob affixed to the needle. The needle does not lock into place.

What is needed is a device that offers superior puncturing function, ease of use, increased safety for the fisherman, and better survivability for the fish.

### SUMMARY OF THE INVENTION

The problem of releasing expanded gases trapped in the swim bladder of fish caught at depth is solved by a device having a retractable puncturing and ventilating member that may be used by fishermen to release those expanded gases. The tool is used by positioning the retracted device between the scales of a fish, operating a trigger mechanism, thereby deploying the puncturing and ventilating member, venting the gases from the swim bladder and operating the trigger mechanism again, thereby retracting the puncturing and ventilating member into a case.

An internal spring-loaded locking mechanism retains the puncturing and ventilating tool safely inside the case when the puncturing tool is not deployed. When the puncturing tool is deployed, the spring-loaded locking mechanism locks the tool in place.

The puncturing member preferably has a pointed, closed end to avoid clogging, with ports on the lateral surface of the member to allow gases to vent to the atmosphere when a fish's swim bladder is punctured.

### BRIEF DESCRIPTION OF THE DRAWINGS

FIG. 1 is a drawing of the disclosed device in use on a fish's swim bladder.

FIG. 2 is a drawing of the disclosed device in the retracted position.

FIG. 2a is a drawing of the disclosed device in the extended position.

FIG. 3 is a drawing of the component parts of the disclosed device.

FIG. 4 is a drawing of the lock gear.

FIG. 5 is a drawing of one embodiment of the puncturing and ventilating member.

FIG. 6 is a drawing of another embodiment of the puncturing and ventilating member with spiral vent ports.

### DETAILED DESCRIPTION

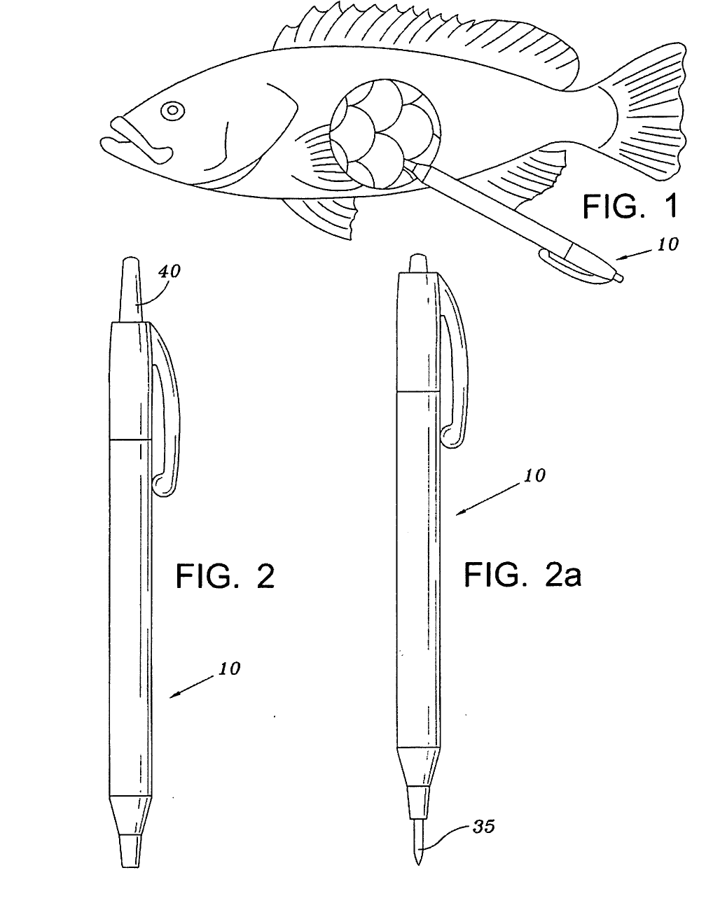

FIG. 1 illustrates a preferred method for employing apparatus or device 10 to vent gases from fish. Device or apparatus 10, in the retracted position shown in FIG. 2, is maneuvered between the scales of a fish above the swim bladder, usually slightly behind the pectoral fin of the fish. The proper technique to locate a swim bladder in fish is well known to fisherman. Trigger 40 is operated, extending puncturing member 35 (FIG. 2a) into the fish and venting the trapped gas.

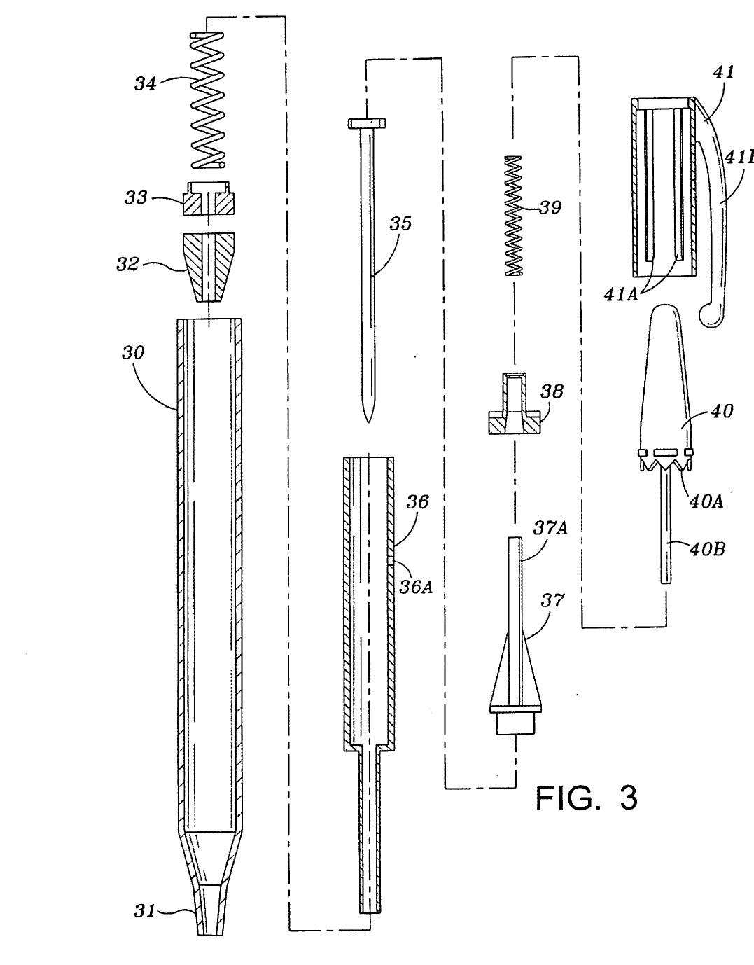

Referring to FIG. 3, case 30 contains the internal components of apparatus 10. Tip 31 is preferably formed with a tapered shape to facilitate maneuvering device 10 under fish scales. Puncturing member 35 is vented to the atmosphere, as will be shown in detail below. Sterilizer pad 32 may be inserted to contact the puncturing tool as the puncturing tool is extended and retracted from the case. Sterilizer pad 32 may be a porous material that has been saturated with a disinfectant. In one embodiment, puncturing member 35 is made of a length of hard metal, with a closed, sharp point at a distal end to aid in puncturing flesh without becoming clogged, a flat proximate end to act as a seat for a retracting mechanism, a hollow center for gas flow, and one or more ports on the lateral surface to facilitate venting (shown in detail in FIGS. 5 and 6).

To assemble apparatus 10, sterilizer 32 is placed at tapered end 31 of case 30. Spring holder/guide 33 is placed behind sterilizer 32 to retain the sterilizer. Spring holder 33 may rest on an internal lip inside case 30 formed by the conical shape of case 30. Main spring 34 is then inserted. Main spring 34 rides between spring holder 33 and the shoulder of chamber 36 formed at the intersection of a larger and smaller diameter, providing a force that retains puncturing member 35 fully inside the case when the apparatus is in the retracted position. Chamber 36 is then inserted. Chamber 36 may have port 36A in the lateral surface. Puncturing member 35 fits through the smaller diameter of chamber 36, with the flat end of puncturing member 35 against the shoulder between the larger and smaller diameters of chamber 16.

The remaining parts of apparatus 10, i.e. parts identified as 37, 38, 39, 40 and 41, make up a trigger mechanism for retracting, extending, and locking puncturing member 35. Cap/guide 37 fits into the wide end of chamber 36 with an end of outer diameter sufficient to fit snugly within the inner diameter of chamber 36, a lip resting on the end of chamber 36, and having hollow cylinder 37A. Parts 38, 39 and 40 are then inserted into case 30 and end cap 41 is press fit to the case.

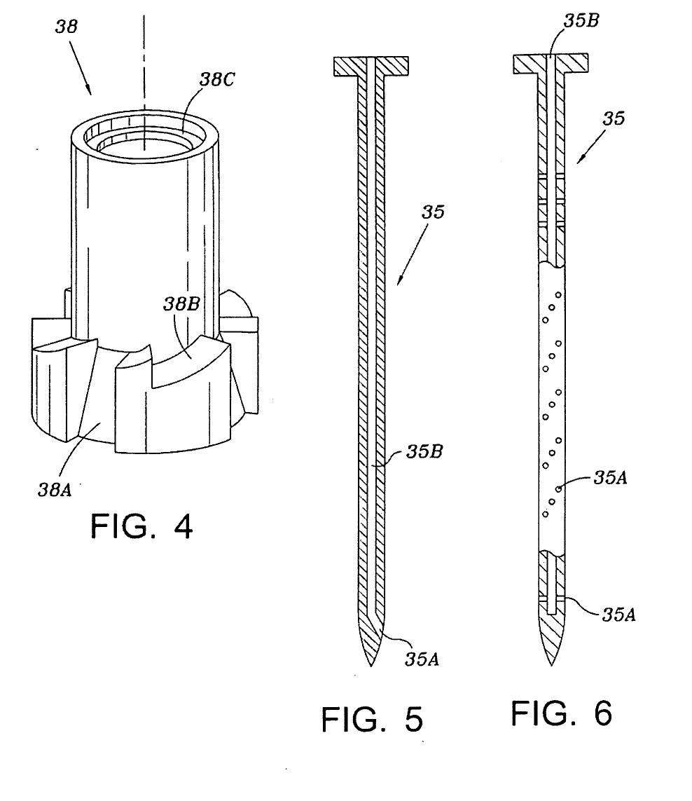

FIG. 4 shows a perspective view of lock gear 38. Inner ring 38C is sized for the larger diameter end of cap/guide 37. Beveled teeth 38B facilitate rotations of lock gear 38 when the trigger mechanism is activated. Lateral grooves 38A, cut between the teeth, are adapted to slide along rails 41A (FIG. 3). The inside diameter of lock gear 38 is sized to be placed over cylindrical part 37A of cap guide 37. Spring 39 is sized to rest on a shoulder in lock gear 38. Button 40, having cylinder 40B sized to be placed in spring 39 is then fitted within end cap 41. Spring 39 provides a force that separates lock gear 38 and button 40. End cap 41 fits over button 40 and into the open end of case 10. The inner surface of end cap 41 provides runners that are used as a track onto which the grooves cut into the beveled teeth of lock gear 38 glide. The runners in end cap 41 extend from the broad end of end cap 41 to a distance from the open end sufficient to allow lock gear 38 to spin freely within the inside of end cap 41.

Depressing button 40 compresses spring 39, moves lock gear 38 beyond the end of the runners in end cap 41, compresses spring 34, which is retaining puncturing member 35, causing puncturing member 35 to extend beyond tapered end 31 of case 30. Teeth 40A on button 40 engage the beveled teeth 38B of lock gear 38, the beveled teeth 38.B of lock gear 38 transfer the linear force to torque, causing lock gear 38 to spin on its axis, which causes the grooves 38A of lock gear 38 to fall out of alignment with the rails 41 A of end piece 41 and causes the beveled teeth 38B of lock gear 38 to become aligned with the end of the rails 41A of end cap 41. End cap 41 may have clip 41B for clipping apparatus 10 in a pocket of a fisherman. Main spring 34 provides linear force acting against lock gear 38, retaining the beveled teeth 38B of lock gear 38 against the end of the rails 41A of end cap 41, and holding the puncturing member 35 in the extended position. As main spring 34 decompresses, puncturing member 35 retracts inside case 10 and is retained by spring 34.

Illustrated in FIG. 5 is one embodiment of puncturing member 35. In this embodiment, port 35A allows gas a path to the hollow center of the puncturing tool. The gas can then escape out of the open end of the tool. A sharp, closed tip and a port near the distal end of the lateral surface of the member may avoid flesh clogs associated with open end “hypodermic” style needles. Alternately, a port may be located at the distal end of the elongated member, or at any other location on the member.

Illustrated in FIG. 6 is another embodiment for the puncturing member. Ports in a spiral pattern around the lateral surface of the puncturing tool allow gases to escape out of the open end of the puncturing tool or from other ports that are outside the fish. A sharp, closed tip and ports on the lateral surface of the member avoid flesh clogs associated with open “hypodermic” style needles.

Although the present invention has been described with respect to specific details, it is not intended that such details should be regarded as limitations on the scope of the invention, except to the extent that they are included in the accompanying claims.

I claim:

1. An apparatus for venting gases from fish comprising:
a) a case having an axis and a distal end;
b) a puncturing member having a sharp distal end and at least one port to provide flow to the exterior of the case;
c) a main spring adapted to fit inside the case and to apply force to the puncturing member in an axial direction; and
d) a trigger mechanism for extending, retracting and locking the puncturing member.

2. The apparatus of claim 1 wherein the trigger mechanism comprises a rotating lock gear having beveled teeth and grooves, a spring, a button having beveled teeth and an end cap having runners adapted to allow grooves in the lock gear to move in an axial direction along the grooves.

3. The apparatus of claim 1 further comprising: a sterilization pad adapted to fit within the case and allow movement of the puncturing member therethrough.

4. The apparatus of claim 1 wherein the puncturing member includes a plurality of ports.

5. The apparatus of claim 1 wherein the case further comprises a clip attached thereto.

6. The apparatus of claim 1 wherein the distal end of the case is tapered for placement under the scales of a fish.

7. The apparatus of claim 1 wherein the port of the puncturing element is disposed on a lateral surface of the puncturing member.

8. A method for venting gases from fish, comprising:
providing the apparatus of claim 1;
maneuvering the distal end of the case between the scales of a fish;
operating the trigger mechanism to extend the puncturing member into a fish; and
operating the trigger mechanism to retract the puncturing member.

9. The method of claim 7 further comprising placing a sterilizer or disinfecting agent in the case before maneuvering the distal end of the case between the scales of a fish.
